(19) United States
(12) Patent Application Publication
(10) Pub. No.: US 2002/0184227 A1
(43) Pub. Date: Dec. 5, 2002

(54) Extendable data scheme

(76) Inventors: Eitan Tobi, Netanya (IL); Ezer Goshen, Or Yehuda (IL); Dov Levanon, Hod Hasharon (IL); Yehoshua Vizogrod, Modi'in Illit (IL)

Correspondence Address: Y. ROCKY TSAO, Fish & Richardson P.C., 225 Franklin Street, Boston, MA, 02110-2804, US

(21) Appl. No.: 09/841,937

(22) Filed: Apr. 25, 2001

(51) Int. Cl. G06F 7/00

(52) U.S. Cl. 707/101

(57) ABSTRACT

A memory encoding a data scheme is described. The data scheme is used for describing one or more associated data elements and comprises a plurality of pre-agreed data fields for data of pre-agreed types describing one or more pre-agreed aspects of the data element(s) and one or more extension fields. The extension fields each include an identifier identifying the field as an extension field and non-pre-agreed data describing one or more aspects of the data element(s).

### FIELD OF THE INVENTION

The present invention relates to a data scheme that is extendable so as to include support for new features and device requirements.

### BACKGROUND OF THE INVENTION

Industry is full of standards. The computer and data communication industries are based around levels of standards, some of which are built upon others and some of which conflict. For example, devices may be built to support all the features of an agreed standard. The standard may be a common operating system such as Windows or an agreement of supported features or instruction types between manufacturers or members of a forum. A standard may also be dictated by a single manufacturer or a single recognised body such as the IEEE.

However, such industries and their associated technology evolve so quickly that almost as soon as a standard is agreed, it is out of date. In such cases, a new standard must be agreed or manufacturers move away from the agreed standards to produce their own so-called compatible standard or provide devices that support extensions to existing standards.

In each case, the move is away from an existing, agreed, standard towards something that only a subset of manufacturers or devices participating in the standard support. Whilst in the case of devices, this can be somewhat of an annoyance having to ensure that the device you purchase is compatible with whichever standard you are attempting to use it with, in the case of data communications, the existence of multiple different standards and their different instructions sets is extremely disadvantageous.

Metadata, data about data, is used to describe, among other things, multimedia content. In multimedia content provision, such as over broadband networks, a metadata file, typically an XML file, is provided alongside the multimedia content. The file typically summarises the content, gives details on technical and legal requirements when using the content and may also identify the author, producer and distributor of the content. In addition to providing the receiving device with sufficient information to provide the content to the end user, metadata is also used for searching for content by search engines searching associated metadata files by keyword or the like. In the case of the Internet and World Wide Web, it is said that “metadata has the potential to transform the web from being machine readable to be machine understandable”. The integrity and standardisation of metadata is seen as a priority for all parties involved in its development.

In order to preserve the integrity of metadata, standards are agreed between parties that limit the usable metadata. Metadata is comprises of elements and architecture. Elements are normally in the form of fields and are the building blocks of metadata. These are the descriptors for the contents, forms and or functions of the described resource. Examples of elements commonly used to describe the intellectual content of a resource are the “author” and “title” fields. A standard normally limits metadata to a pre-agreed set of elements. The Dublin Core metadata set is a simple semantic metadata set. The Dublin Core was agreed between an International group of cross-disciplinary experts which led to a simple yet descriptive set of metadata elements. However, the Dublin Core was agreed over five years ago and only provides a very high level, generic level of description. Thus, description of aspects of new technology and fine detail is not possible under this standard. It is desirable to provide a standard that is arbitrarily extendible yet satisfies the standard and can be semantically understood by devices only supporting the basic standard.

### STATEMENT OF THE INVENTION

According to a first aspect of the present invention, there is provided 1. A memory encoding a data scheme describing one or more associated data elements, the data scheme comprising a plurality of pre-agreed data fields for data of pre-agreed types describing one or more pre-agreed aspects of the data element(s) and one or more extension fields each including an identifier identifying the field as an extension field and non-pre-agreed data describing one or more aspects of the data element(s).

The data scheme in the present invention is divided into a number of pre-agreed data fields that may have been agreed in accordance with some predetermined standard. In addition, extension fields including data that is not part of the standard may also be included in the data scheme. Using extension fields, a vendor, content supplier or service supplier can include additional information needed by themselves or their devices to support their content or services. In this manner, a standard, typically a metadata standard, coexists with vendor specific extensions. Non-standard metadata becomes an integral part of a standard metadata file. The standard metadata can be understood by all that support the standard. The extension fields offer descriptive capabilities in addition to the standard and need only be supported by devices or applications requiring such data.

The data scheme may comprise a metadata file, preferably an extendible mark-up language, XML, file.

The pre-agreed data fields may comprise fields selected from the Dublin Core. Preferably, the pre-agreed data fields comprise fields selected from a refined Dublin Core, the refined Dublin Core having redundant data fields removed.

A device may be programmed to access such a data scheme, the device comprising a processor and a memory, the memory storing data on the pre-agreed data fields and data on one or more of the extension fields, wherein the processor is arranged to access the memory to process the pre-agreed data fields of the data scheme, to determine the extension fields from the data scheme on which the memory holds data on and to process the non-pre-agreed data associated with those extension fields.

According to another aspect of the present invention, there is provided a computer-readable medium, on which is stored a computer program of instructions for a device to process a metadata file describing one or more associated data elements comprising, in combination:

means for enabling the device to access the metadata file;

means for enabling the device to access a data scheme in a memory, the data scheme comprising a plurality of pre-agreed data fields for data of pre-agreed types describing one or more pre-agreed aspects of the data element(s) and one or more extension fields each including an identifier identifying the field as an extension field and non-pre-agreed data describing one or more aspects of the data element(s);

means for enabling the computer to process pre-agreed data fields of the metadata file in dependence on the data scheme;

means for enabling the computer the determine extension fields in the metadata file that correspond to extension fields in the data scheme in the memory; and,

means for enabling the computer to process the corresponding extension files in dependence on the data scheme in the memory.

According to another aspect of the present invention, there is provided a method of processing a metadata file describing one or more associated data elements, comprising:

accessing a data scheme in a memory, the data scheme defining a plurality of pre-agreed data fields for data of pre-agreed types describing one or more pre-agreed aspects of the data element(s) and one or more extension fields for non-pre-agreed data describing one or more aspects of the data element(s);

processing fields of the metadata file corresponding to pre-agreed fields in dependence on the data scheme;

determining the extension fields in the metadata file from identifiers identifying the field as an extension field; and,

processing the extension fields if they correspond to extension fields associated with the data scheme in the memory.

### BRIEF DESCRIPTION OF THE DRAWINGS

An example of the present invention will now be described in detail, with reference to the accompanying drawings, in which:

FIG. 1 is a schematic diagram of a computer system suitable for implementing the present invention; and,

FIGS. 2 and 3 are example metadata files incorporating the data scheme according to the present invention.

### DETAILED DESCRIPTION

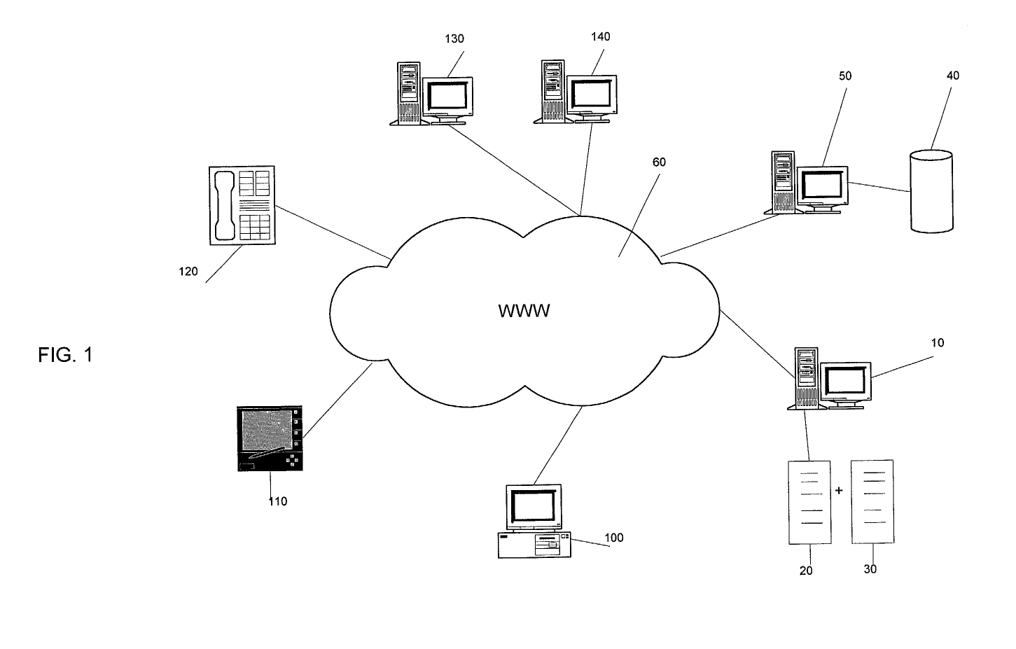

FIG. 1 is a schematic diagram of a computer system suitable for implementing the present invention.

A content supplier 10 supplies a content file 20 and an associated metadata file 30 to a content repository 40 hosted by an Internet server 50 on the World Wide Web 60. The metadata file 30 is in accordance with an agreed standard and incorporates a number of extension fields.

User terminals that may be, for example, in the form of a personal computer 100, a PDA 110 and a mobile telephone 120 are able to access the repository 40 to obtain the metadata file and the content. Search engines, 140 and 150, may also able to access the repository to obtain the content and metadata file.

In this particular example, the search engines and the user terminals all support the agreed standard and are able to access and understand the parts of the metadata file 30 that meet the agreed standard. However, the search engine 150 also supports a number of the extension fields. Upon obtaining the metadata file, the search engine determines the existence of the extension fields from a pre-agreed labelling scheme within the metadata file and is then able to use those extension fields it semantically understands. The user terminal 110 may also be able to use a number of the extension fields. These may be the same or different to those used by the search engine. Again, upon accessing the metadata file, those extension fields applicable to the user terminal are extracted from the metadata file by the user terminal and processed accordingly.

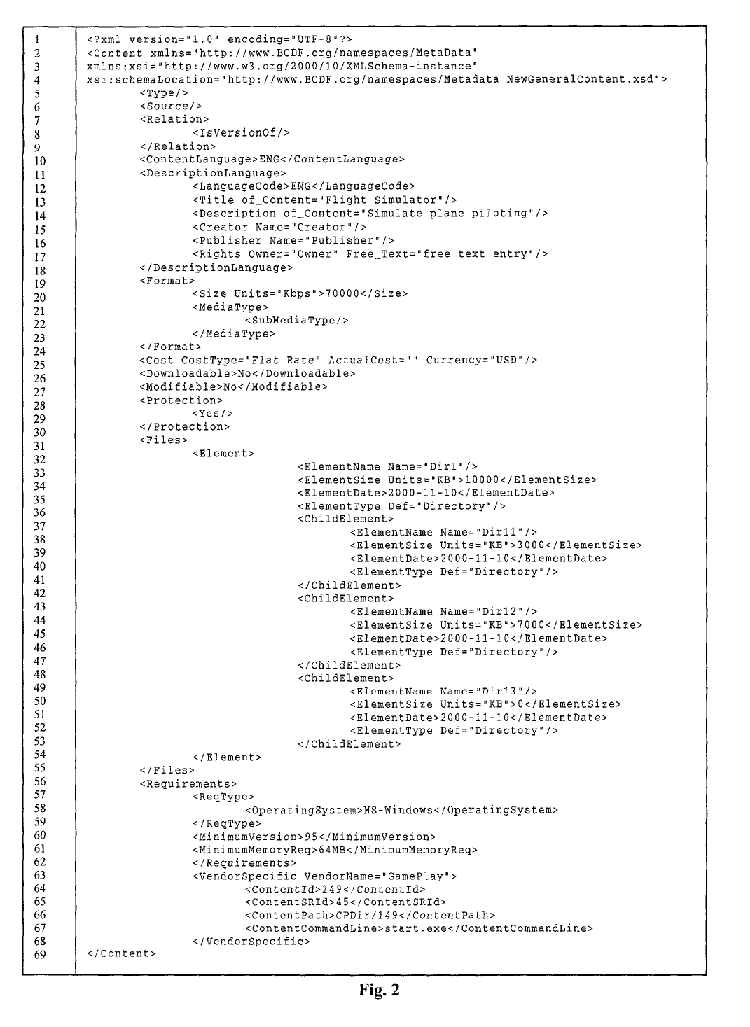

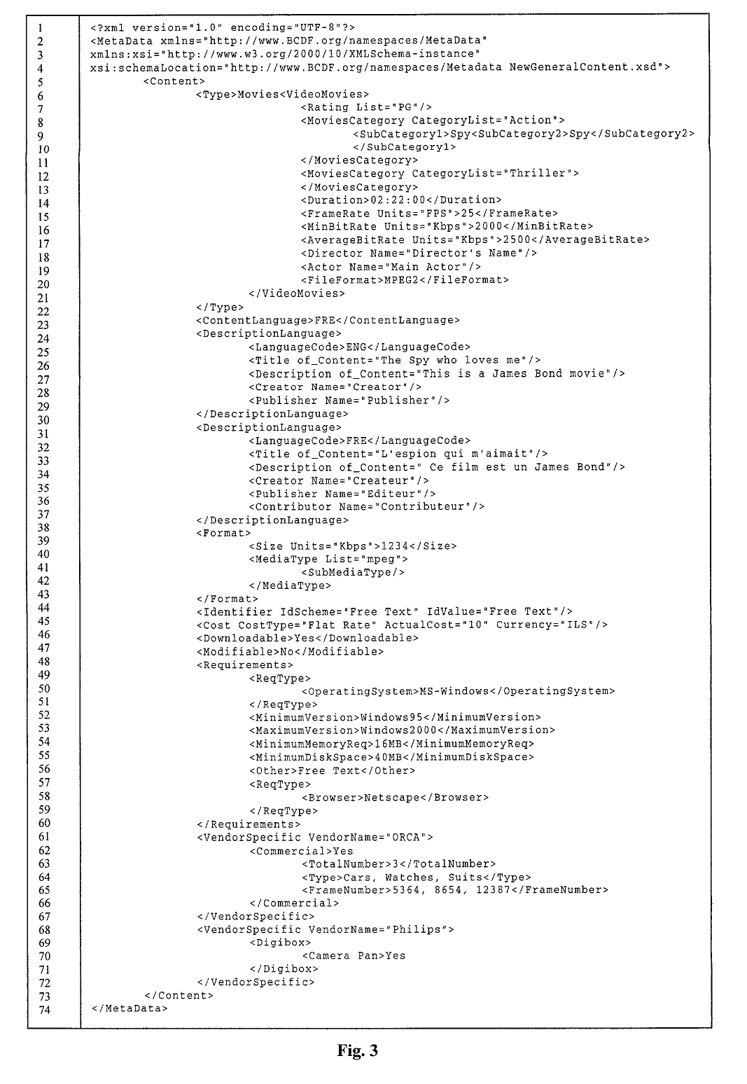

FIGS. 2 and 3 are example metadata file incorporating a data scheme according to the present invention. The line numbers shown next to the metadata of the metadata files are for illustration purposes only and are not normally included in metadata files.

The standard proposed is based on the Dublin Core elements. However, some of these elements are duplicated and therefore redundant. Such elements have been dropped.

Table 1 is a list of the elements used for describing aspects of
content in a broadband content provision standard.

| Descriptor | Content | Comment |
|---|---|---|
| Title | Free text Content’s name | Limited to 512 characters |
| Type | 1. Movies | |
| | 2. Video | |
| | 3. Audio | |
| | 4. Live Broadcast | |
| | S. Productivity | |
| | 6. E-Learning | |
| | 7. Entertainment | |
| | 8. Web Sites | |
| | 9. Computer Files | |
| Language | Three letter, language code | According to ISO 639-2/B |
| Descrip- | Free text Abstract, TOC | Limited to 4096 characters |
| tion | | |
| Format | 1. Size | Size is in KBytes |
| | 2. Media type | Media types according to |
| | | RFC2046 |
| Date | 1. Create | Date & Time format should |
| | 2. Available | be according to ISO 8601. |
| | 3. Unavailable | At least one from the list |
| | 4. Issued | should appear. |
| | 5. Modified | Time is optional. |
| | 6. Valid | |
| | 7. Delete | |
| Creator | Free text Author’s name | Limited to 512 characters |
| Publisher | Free text Publisher’s name | Limited to 512 characters |
| Contri- | Free text | Optional. Limited to 512 |
| butor | | characters |
| Rights | 1. Owner | 1. Limited to 512 |
| | 2. Free text, | characters |
| | disclaimer | 2. Limited to 4096 |
| | | characters |
| Identfier | 1. Identifier type | Free text (UPC Universal |
| | 2. Identifier value | Product Code, EAN |
| | | European Article Number, |
| | | URL, etc . . . ) |
| | | 1. Limited to 512 |
| | | characters |
| | | 2. Limited to 1024 |
| | | characters |
| Cost | 1. Flat rate | Support for other business |
| | 2. Per user per session (Time | models should be |
| | limit) | available. |
| | 3. Per X times of usages | Currency is according to |
| | 4. Per X concurrent users | ISO 4217 |
| | Actual Cost and Currency | |
| Down- | Yes/No | Flags if content can be |
| loadable | | downloaded. |
| Modified | Yes/No | Flags if content can be |
| | | modified. |
| Protection | 1. Maximum | |
| | 2. Normal | |
| | 3. Unprotected | |
| DRM | | Optional |
| Files | File list and directory structure | Name Limited to 512 |
| | Parameters: Name, Size, Date, | characters |
| | Type {Dir, File} | Size in Kbytes |
| | | Date according to ISO 8601 |
| Require- | Type {Operating system, | |
| ments | Browser} | |
| | Operating system {PC-DOS, | |
| | MS-Windows, MacOS, | |
| | UNIX Multi-OS, Other, | |
| | None} | |
| | Browser {Any, Netscape, | |
| | Explorer, Opera} | |
| | MinimumVersion | |
| | MaximumVersion | |
| | Other - Free text | Other SW and HW |
| | | requirements. |
| | | Limited to 1024 characters |

A number of further standard elements for describing aspects including cost, ability for content to be downloaded, date modified, protection, DRM, files and requirements have also been added to the Dublin Core.

The architecture of the metadata file is in the form of a hierarchy. The hierarchy is formed due to branching within a metadata file for repetition of elements for different languages or content. Not all of the elements need to be used in a metadata file.

FIG. 2 is a metadata file defining a flight simulator game. Lines 1 to 62 define the game, the location of its files and the system requirements for a computer system to be able to run the game. Lines 63 onwards define extra data in the form of extra fields that are specific to the GamePlay system that allows online multi-user interactive games. The extra fields specific to GamePlay are identified with the “<VendorSpecific>GamePlay” tag. All computer systems compatible with the standard are able to access the metadata file and run the game locally in a single player mode if they satisfy the system requirements. However, a system compatible with the GamePlay system is able to use the files to access an online multi-user interactive version of the game.

Data to be provided in addition to that defined within the standard is identified as an extra field with a “vendor-specific” tag. Thus a vendor can include additional information and identify it as being associated with that vendor. A receiving device that knows of the existence of the extra fields can detect and use the data, others merely operate using the standard-based data in ignorance of the extra fields.

In FIG. 3, the metadata file defines a movie “The Spy who loved me”. Lines 1 to 62 define the movie in terms of its rating, category, frame rate and requirements. It will be noted that the <DescriptionLangauge> field is repeated on lines 23 to 31 and 32 to 40 to provide the description in English and French. This results in a hierarchical tree forming within the metadata file, each branch relating to a respective repetition of data.

Lines 62 to 71 define the extra fields. The fields are encapsulated within <VendorSpecific> tags. In this example, a vendor specific tag for Orca video servers is provided giving information on commercials that should be inserted at predetermined frames within the movie. Line 64 defines the type of commercial to be inserted whilst line 65 defines the frame at which the commercial should be inserted. An Orca server accessing the metadata file of FIG. 3 is able to semantically understand the extra fields and insert appropriate commercials.

A second vendor specific set of extra fields are also provided for Philips digital decoder in lines 69 to 71. Such a device receiving the metadata file is able to determine that alternative camera pan angles are available to viewers and is then able to activate this feature.

In both cases, devices that are not able to semantically understand some or all of the extra fields simply ignore them. This particular example illustrates that a device understanding one set of extra fields need not necessarily be able to understand another set within the same metadata field.

Whilst the present invention has been described with respect to metadata for multimedia content distribution, it will be apparent that it could be applied to seamlessly extend any standardised multimedia description files.

1. A memory encoding a data scheme describing one or more associated data elements, the data scheme comprising a plurality of pre-agreed data fields for data of pre-agreed types describing one or more pre-agreed aspects of the data element(s) and one or more extension fields each including an identifier identifying the field as an extension field and non-pre-agreed data describing one or more aspects of the data element(s).

2. A memory according to claim 1, in which the data scheme comprises a metadata file.

3. A memory according to claim 2, in which the file comprises an extendible mark-up language, XML, file.

4. A memory according to claim 1, in which the pre-agreed data fields comprise fields selected from the Dublin Core.

5. A memory according to claim 4, in which the pre-agreed data fields comprise fields selected from a refined Dublin Core, the refined Dublin Core having redundant data fields removed.

6. A device programmed to access a data scheme according to claim 1 comprising a processor and a memory, the memory storing data on the pre-agreed data fields and data on one or more of the extension fields, wherein the processor is arranged to access the memory to process the pre-agreed data fields of the data scheme, to determine the extension fields from the data scheme on which the memory holds data on and to process the non-pre-agreed data associated with those extension fields.

7. A computer readable medium on which is encoded the data scheme of claim 1.

8. A computer-readable medium, on which is stored a computer program of instructions for a device to process a metadata file describing one or more associated data elements comprising, in combination:
means for enabling the device to access the metadata file;
means for enabling the device to access a data scheme in a memory, the data scheme comprising a plurality of pre-agreed data fields for data of pre-agreed types describing one or more pre-agreed aspects of the data element(s) and one or more extension fields each including an identifier identifying the field as an extension field and non-pre-agreed data describing one or more aspects of the data element(s);
means for enabling the computer to process pre-agreed data fields of the metadata file in dependence on the data scheme;
means for enabling the computer the determine extension fields in the metadata file that correspond to extension fields in the data scheme in the memory; and,
means for enabling the computer to process the corresponding extension files in dependence on the data scheme in the memory.

9. A method of processing a metadata file describing one or more associated data elements, comprising:
accessing a data scheme in a memory, the data scheme defining a plurality of pre-agreed data fields for data of pre-agreed types describing one or more pre-agreed aspects of the data element(s) and one or more extension fields for non-pre-agreed data describing one or more aspects of the data element(s);
processing fields of the metadata file corresponding to pre-agreed fields in dependence on the data scheme;
determining the extension fields in the metadata file from identifiers identifying the field as an extension field; and,
processing the extension fields if they correspond to extension fields associated with the data scheme in the memory.

10. A program storage device readable by a machine and encoding a program of instructions for executing the method steps of claim 9.
